(19) United States
(12) Patent Application Publication
(10) Pub. No.: US 2010/0008590 A1
(43) Pub. Date: Jan. 14, 2010

(54) Signature of Moulded Article

(75) Inventor: Russell Paul Cowburn, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Ingenia Holdings (UK) Limited, London (GB)

(21) Appl. No.: 12/501,305

(22) Filed: Jul. 10, 2009

Related U.S. Application Data
(60) Provisional application No. 61/079,992, filed on Jul. 11, 2008.

(30) Foreign Application Priority Data
Jul. 11, 2008 (GB) 0812773.0

(51) Int. Cl. G06K 9/68

(52) U.S. Cl. 382/218

(57) ABSTRACT

A method of authenticating an article comprises generating a signature from intrinsic surface structure of an article, comparing the signature for the article to a stored signature for a mould used to produce articles, and determining an authentication result based upon a comparison result between the article signature and stored mould signature.

### FIELD

The present invention relates to signatures from moulded articles and in particular but not exclusively to mould signatures for injection moulded articles.

### BACKGROUND

Many traditional authentication systems rely on a process which is difficult for anybody other than the manufacturer to perform, where the difficulty may be imposed by expense of capital equipment, complexity of technical know-how or preferably both. Examples are the provision of a watermark in bank notes and a hologram on credit cards or passports. Unfortunately, criminals are becoming more sophisticated and can reproduce virtually anything that original manufacturers can do. Furthermore, such systems are typically too expensive and complicated for tasks such as product tracking for quality control and warranty purposes.

Because of this, there is a known approach to authentication systems which relies on creating security tokens using some process governed by laws of nature which results in each token being unique, and more importantly having a unique characteristic that is measurable and can thus be used as a basis for subsequent verification. According to this approach tokens are manufactured and measured in a set way to obtain a unique characteristic. The characteristic can then be stored in a computer database, or otherwise retained. Tokens of this type can be embedded in the carrier article, e.g. a banknote, passport, ID card, important document. Subsequently, the carrier article can be measured again and the measured characteristic compared with the characteristics stored in the database to establish if there is a match. However, such systems are often still too expensive and/or complicated for tasks such as product tracking for quality control and warranty purposes.

James D. R. Buchanan et al in “Forgery: ‘Fingerprinting’ documents and packaging”, Nature 436, 475-475 (28 Jul. 2005) describes a system for using reflected laser light from an article to uniquely identify the article with a high degree of reproducability not previously attained in the art. Buchanan's technique samples reflections from an article surface a number of times at each of multiple points in the surface to create a signature or “fingerprint” for the article.

The present invention has been conceived in the light of known drawbacks of existing systems.

### SUMMARY

The inventors' investigations into optical techniques for optically obtaining information describing the surface roughness or texture of an article and for obtaining a signature which identifies that particular article from other similar (macroscopically identical or similar) articles has led to the present invention, in which an article can be authenticated to a record signature database, without the database needing to already contain a record signature determined from the article to be authenticated. Rather, the present invention provides for the use of a class signature based record database, where each article produced from a single mould can be authenticated by reference to a signature associated with that mould.

Viewed from a first aspect, the present invention provides a method of authenticating an article. The method comprises generating a signature from an article using a method of directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points; comparing the signature for the article to a stored signature for a mould used to produce articles; and determining an authentication result based upon a comparison result between the article signature and stored mould signature.

Thereby, a small record database size can be provided whilst not compromising the ability to reliably authenticate genuine articles without falsely accepting non-genuine articles. By use of such a method, efficient and accurate verification of a large number of articles can be carried out. The reduced database size makes the technology particularly accessible to, for example, quality control tracking of small unit value high unit quantity articles such as product components.

In some examples, the stored signature for the mould is generated from a sample of fewer than all articles produced from the mould. Thereby, a database population stage can be kept simple and inexpensive, with only a small sample of the articles being produced from each mould needing to be used for record database generation.

In some examples, the signature for the article includes signature elements relating uniquely to the article in addition to elements relating to the mould. Such dual signature elements allow a two-tier approach to be adopted where for some purposes authentication to a mould signature is appropriate (for example quality control related to mould induced defects), and for other purposes authentication to an individual article signature is appropriate (for example some purpose relating to the identify of the article owner).

In some examples, the article is produced by injection moulding of thermosetting plastics material or thermoplastics material.

Viewed from another aspect, the present invention provides a system for authenticating an article. The system comprises a signature generator operable to generate a signature from an article using a method of directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points; a comparator operable to compare the signature for the article to a stored signature for a mould used to produce articles; and a determiner operable to determine an authentication result based upon a comparison result between the article signature and stored mould signature.

Thereby, a small record database size can be provided whilst not compromising the ability to reliably authenticate genuine articles without falsely accepting non-genuine articles. By use of such a system, efficient and accurate verification of a large number of articles can be carried out. The reduced database size makes the technology particularly accessible to, for example, quality control tracking of small unit value high unit quantity articles such as product components.

Further objects and advantages of the invention will become apparent from the following description and the appended claims.

### BRIEF DESCRIPTION OF THE DRAWINGS

For a better understanding of the invention and to show how the same may be carried into effect reference is now made by way of example to the accompanying drawings in which:

FIG. 1 shows a schematic side view of a reader apparatus;

FIG. 2 shows a block schematic diagram of functional components of the reader apparatus;

FIG. 3 is a microscope image of a paper surface;

FIG. 4 shows an equivalent image for a plastic surface;

FIG. 5 shows a flow diagram showing how a signature of an article can be generated from a scan;

FIG. 6 is a flow diagram showing how a signature of an article obtained from a scan can be verified against a signature database;

FIG. 7a is a plot illustrating how a number of degrees of freedom can be calculated;

FIG. 7b is a plot illustrating how a number of degrees of freedom can be calculated;

FIG. 8 is a flow diagram showing the overall process of how a document is scanned for verification purposes and the results presented to a user;

FIG. 9a is a flow diagram showing how the verification process of FIG. 6 can be altered to account for non-idealities in a scan;

FIG. 9b is a flow diagram showing another example of how the verification process of FIG. 6 can be altered to account for non-idealities in a scan;

FIG. 10A shows an example of cross-correlation data gathered from a scan;

FIG. 10b shows an example of cross-correlation data gathered from a scan where the scanned article is distorted;

FIG. 10C shows an example of cross-correlation data gathered from a scan where the scanned article is scanned at non-linear speed;

FIG. 11 is a flow diagram showing conceptual process steps for generating a record signature database; and

FIG. 12 is a flow diagram showing conceptual process steps for authenticating against a record signature database.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### SPECIFIC DESCRIPTION

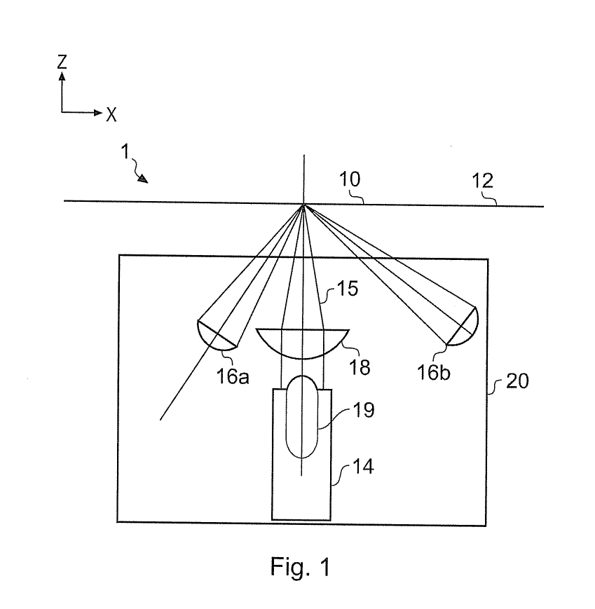

To provide an accurate method for uniquely identifying an article, it is possible to use a system which relies upon optical reflections from a surface of the article. An example of such a system will be described with reference to FIGS. 1 to 10.

The example system described herein is one developed and marketed by Ingenia Technologies Ltd. This system is operable to analyse the random surface patterning of a paper, cardboard, plastic or metal article, such as a sheet of paper, an identity card or passport, a security seal, a payment card etc to uniquely identify a given article. This system is described in detail in a number of published patent applications, including GB0405641.2 filed 12 Mar. 2004 (published as GB2411954 14 Sep. 2005), GB0418138.4 filed 13 Aug. 2004 (published as GB2417707 8 Mar. 2006), U.S. 60/601,464 filed 13 Aug. 2004, U.S. 60/601,463 filed 13 Aug. 2004, U.S. 60/610,075 filed 15 Sep. 2004, GB 0418178.0 filed 13 Aug. 2004 (published as GB2417074 15 Feb. 2006), U.S. 60/601,219 filed 13 Aug. 2004, GB 0418173.1 filed 13 Aug. 2004 (published as GB2417592 1 Mar. 2006), U.S. 60/601,500 filed 13 Aug. 2004, GB 0509635.9 filed 11 May 2005 (published as GB2426100 15 Nov. 2006), U.S. 60/679,892 filed 11 May 2005, GB 0515464.6 filed 27 Jul.-2005 (published as GB2428846 7 Feb. 2007), U.S. 60/702,746 filed 27 Jul. 2005, GB 0515461.2 filed 27 Jul. 2005 (published as GB2429096 14 Feb. 2007), U.S. 60/702,946 filed 27 Jul. 2005, GB 0515465.3 filed 27 Jul. 2005 (published as GB2429092 14 Feb. 2007), U.S. 60/702,897 filed 27 Jul. 2005, GB 0515463.8 filed 27 Jul. 2005 (published as GB2428948 7 Feb. 2007), U.S. 60/702,742 filed 27 Jul. 2005, GB 0515460.4 filed 27 Jul. 2005 (published as GB2429095 14 Feb. 2007), U.S. 60/702,732 filed 27 Jul. 2005, GB 0515462.0 filed 27 Jul. 2005 (published as GB2429097 14 Feb. 2007), U.S. 60/704,354 filed 27 Jul. 2005, GB 0518342.1 filed 8 Sep. 2005 (published as GB2429950 14 Mar. 2007), U.S. 60/715,044 filed 8 Sep. 2005, GB 0522037.1 filed 28 Oct. 2005 (published as GB2431759 2 May 2007), and U.S. 60/731,531 filed 28 Oct. 2005 (all invented by Cowburn et al.), the content of each and all of which is hereby incorporated hereinto by reference.

By way of illustration, a brief description of the method of operation of the Ingenia Technologies Ltd system will now be presented.

FIG. 1 shows a schematic side view of a reader apparatus 1. The optical reader apparatus 1 is for measuring a signature from an article (not shown) arranged in a reading volume of the apparatus. The reading volume is formed by a reading aperture 10 which is a slit in a housing 12. The housing 12 contains the main optical components of the apparatus. The slit has its major extent in the x direction (see inset axes in the drawing). The principal optical components are a laser source 14 for generating a coherent laser beam 15 and a detector arrangement 16 made up of a plurality of k photodetector elements, where k=2 in this example, labelled 16a and 16b. The laser beam 15 is focused by a focussing arrangement 18 into an elongate focus extending in the y direction (perpendicular to the plane of the drawing) and lying in the plane of the reading aperture. In one example reader, the elongate focus has a major axis dimension of about 2 mm and a minor axis dimension of about 40 micrometres. These optical components are contained in a subassembly 20. In the illustrated example, the detector elements 16a, 16b are distributed either side of the beam axis offset at different angles from the beam axis to collect light scattered in reflection from an article present in the reading volume. In one example, the offset angles are −30 and +50 degrees. The angles either side of the beam axis can be chosen so as not to be equal so that the data points they collect are as independent as possible. However, in practice, it has been determined that this is not essential to the operation and having detectors at equal angles either side of the incident beam is a perfectly workable arrangement. All four detector elements are arranged in a common plane. The photodetector elements 16a and 16b detect light scattered from an article placed on the housing when the coherent beam scatters from the reading volume. As illustrated, the source is mounted to direct the laser beam 15 with its beam axis in the z direction, so that it will strike an article in the reading aperture at normal incidence.

Generally it is desirable that the depth of focus is large, so that any differences in the article positioning in the z direction do not result in significant changes in the size of the beam in the plane of the reading aperture. In one example, the depth of focus is approximately ±2 mm which is sufficiently large to produce good results. In other arrangements, the depth of focus may be greater or smaller. The parameters, of depth of focus, numerical aperture and working distance are interdependent, resulting in a well known trade off between spot size and depth of focus. In some arrangements, the focus may be adjustable and in conjunction with a rangefinding means the focus may be adjusted to target an article placed within an available focus range.

In order to enable a number of points on the target article to be read, the article and reader apparatus can be arranged so as to permit the incident beam and associated detectors to move relative to the target article. This can be arranged by moving the article, the scanner assembly or both. In some examples, the article may be held in place adjacent the reader apparatus housing and the scanner assembly may move within the reader apparatus to cause this movement. Alternatively, the article may be moved past the scanner assembly, for example in the case of a production line where an article moves past a fixed position scanner while the article travels along a conveyor. In other alternatives, both article and scanner may be kept stationary, while a directional focus means causes the coherent light beam to travel across the target. This may require the detectors to move with the light bean, or stationary detectors may be positioned so as to receive reflections from all incident positions of the light beam on the target.

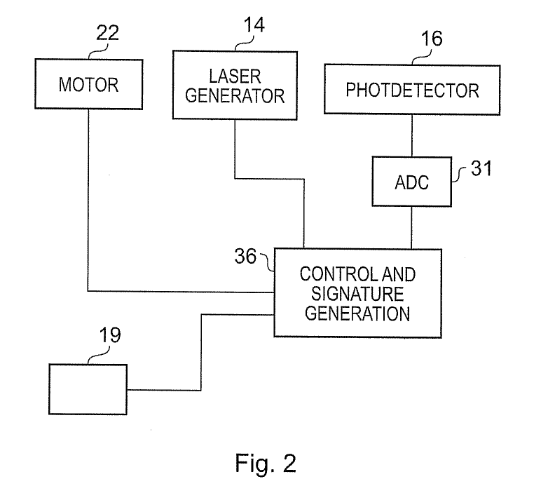

FIG. 2 is a block schematic diagram of logical components of a reader apparatus as discussed above. A laser generator 14 is controlled by a control and signature generation unit 36. Optionally, a motor 22 may also be controlled by the control and signature generation unit 36. Optionally, if some form of motion detection or linearization means (shown as 19) is implemented to measure motion of the target past the reader apparatus, and/or to measure and thus account for non-linearities in there relative movement, this can be controlled using the control and signature generation unit 36.

The reflections of the laser beam from the target surface scan area are detected by the photodetector 16. As discussed above, more than one photodetector may be provided in some examples. The output from the photodetector 16 is digitised by an analog to digital converter (ADC) 31 before being passed to the control and signature generation unit 36 for processing to create a signature for a particular target surface scan area. The ADC can be part of a data capture circuit, or it can be a separate unit, or it can be integrated into a microcontroller or microprocessor of the control and signature generation unit 36 .

The control and signature generation unit 36 can use the laser beam present incidence location information to determine the scan area location for each set of photodetector reflection information. Thereby a signature based on all or selected parts of the scanned part of the scan area can be created. Where less than the entire scan area is being included in the signature, the signature generation unit 36 can simply ignore any data received from other parts of the scan area when generating the signature. Alternatively, where the data from the entire scan area is used for another purpose, such as positioning or gathering of image-type data from the target, the entire data set can be used by the control and signature generation unit 36 for that additional purpose and then kept or discarded following completion of that additional purpose.

As will be appreciated, the various logical elements depicted in FIG. 2 may be physically embodied in a variety of apparatus combinations. For example, in some situations, all of the elements may be included within a scan apparatus. In other situations, the scan apparatus may include only the laser generator 14, motor 22 (if any) and photodetector 16 with all the remaining elements being located in a separate physical unit or units. Other combinations of physical distribution of the logical elements can also be used. Also, the control and signature generation unit 36 may be split into separate physical units. For example, the there may be a first unit which actually controls the laser generator 14 and motor (if any), a second unit which calculates the laser beam current incidence location information, a third unit which identifies the scan data which is to be used for generating a signature, and a fourth part which actually calculates the signature.

It will be appreciated that some or all of the processing steps carried out by the ADC 31 and/or control and signature generation unit 36 may be carried out using a dedicated processing arrangement such as an application specific integrated circuit (ASIC) or a dedicated analog processing circuit. Alternatively or in addition, some or all of the processing steps carried out by the beam ADC 31 and/or control and signature generation unit 36 may be carried out using a programmable processing apparatus such as a digital signal processor or multi-purpose processor such as may be used in a conventional personal computer, portable computer, handheld computer (e.g. a personal digital assistant or PDA) or a smartphone. Where a programmable processing apparatus is used, it will be understood that a software program or programs may be used to cause the programmable apparatus to carry out the desired functions. Such software programs may be embodied onto a carrier medium such as a magnetic or optical disc or onto a signal for transmission over a data communications channel.

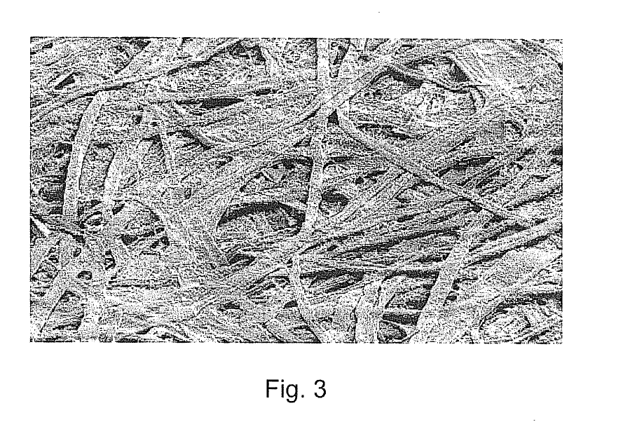

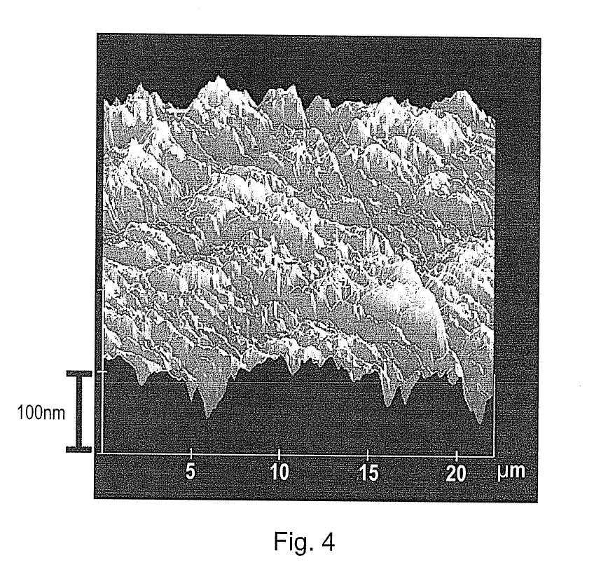

To illustrate the surface properties which the system of these examples can read, FIG. 3 and 4 illustrate a paper and plastic article surface respectively.

FIG. 3 is a microscope image of a paper surface with the image covering an area of approximately 0.5×0.2 mm. This figure is included to illustrate that macroscopically flat surfaces, such as from paper, are in many cases highly structured at a microscopic scale. For paper, the surface is microscopically highly structured as a result of the intermeshed network of wood or other plant-derived fibres that make up paper. The figure is also illustrative of the characteristic length scale for the wood fibres which is around 10 microns. This dimension has the correct relationship to the optical wavelength of the coherent beam to cause diffraction and also diffuse scattering which has a profile that depends upon the fibre orientation. It will thus be appreciated that if a reader is to be designed for a specific class of goods, the wavelength of the laser can be tailored to the structure feature size of the class of goods to be scanned. It is also evident from the figure that the local surface structure of each piece of paper will be unique in that it depends on how the individual wood fibres are arranged. A piece of paper is thus no different from a specially created token, such as the special resin tokens or magnetic material deposits of the prior art, in that it has structure which is unique as a result of it being made by a process governed by laws of nature. The same applies to many other types of article.

FIG. 4 shows an equivalent image for a plastic surface. This atomic force microscopy image clearly shows the uneven surface of the macroscopically smooth plastic surface. As can be surmised from the figure, this surface is smoother than the paper surface illustrated in FIG. 3, but even this level of surface undulation can be uniquely identified using the signature generation scheme of the present examples.

In other words, it is essentially pointless to go to the effort and expense of making specially prepared tokens, when unique characteristics are measurable in a straightforward manner from a wide variety of every day articles. The data collection and numerical processing of a scatter signal that takes advantage of the natural structure of an article's surface (or interior in the case of transmission) is now described.

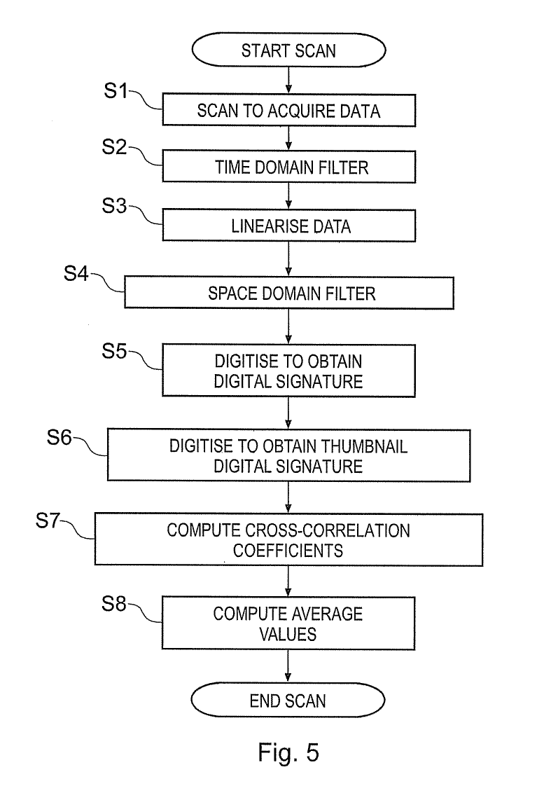

FIG. 5 shows a flow diagram showing how a signature of an article can be generated from a scan.

Step S1 is a data acquisition step during which the optical intensity at each of the photodetectors is acquired at a number of locations along the entire length of scan. Simultaneously, the encoder signal is acquired as a function of time. It is noted that if the scan motor has a high degree of linearisation accuracy (e.g. as would a stepper motor), or if non-linearities in the data can be removed through block-wise analysis or template matching, then linearisation of the data may not be required. Referring to FIG. 2 above, the data is acquired by the signature generator 36 taking data from the ADC 31. The number of data points per photodetector collected in each scan is defined as N in the following. Further, the value ak (i) is defined as the i-th stored intensity value from photodetector k, where i runs from 1 to N.

Step S2 is an optional step of applying a time-domain filter to the captured data. In the present example, this is used to selectively remove signals in the 50/60 Hz and 100/120 Hz bands such as might be expected to appear if the target is also subject to illumination from sources other than the coherent beam. These frequencies are those most commonly used for driving room lighting such as fluorescent lighting.

Step S3 performs alignment of the data. In some examples, this step uses numerical interpolation to locally expand and contract ak(i) so that the encoder transitions are evenly spaced in time. This corrects for local variations in the motor speed and other non-linearities in the data. This step can be performed by the signature generator 36.

In some examples, where the scan area corresponds to a predetermined pattern template, the captured data can be compared to the known template and translational and/or rotational adjustments applied to the captured data to align the data to the template. Also, stretching and contracting adjustments may be applied to the captured data to align it to the template in circumstances where passage of the scan head relative to the article differs from that from which the template was constructed. Thus if the template is constructed using a linear scan speed, the scan data can be adjusted to match the template if the scan data was conducted with non-linearities of speed present.

Step S4 applies a space-domain band-pass filter to the captured data. This filter passes a range of wavelengths in the x-direction (the direction of movement of the scan head). The filter is designed to maximise decay between samples and maintain a high number of degrees of freedom within the data. With this in mind, the lower limit of the filter passband is set to have a fast decay. This is required as the absolute intensity value from the target surface is uninteresting from the point of view of signature generation, whereas the variation between areas of apparently similar intensity is of interest. However, the decay is not set to be too fast, as doing so can reduce the randomness of the signal, thereby reducing the degrees of freedom in the captured data. The upper limit can be set high; whilst there may be some high frequency noise or a requirement for some averaging (smearing) between values in the x-direction (much as was discussed above for values in the y-direction), there is typically no need for anything other than a high upper limit. In some examples a 2^{nd} order filter can be used. In one example, where the speed of travel of the laser over the target surface is 20 mm per second, the filter may have an impulse rise distance 100 microns and an impulse fall distance of 500 microns.

Instead of applying a simple filter, it may be desirable to weight different parts of the filter. In one example, the weighting applied is substantial, such that a triangular passband is created to introduce the equivalent of realspace functions such as differentiation. A differentiation type effect may be useful for highly structured surfaces, as it can serve to attenuate correlated contributions (e.g. from surface printing on the target) from the signal relative to uncorrelated contributions.

Step S5 is a digitisation step where the multi-level digital signal (the processed output from the ADC) is converted to a bi-state digital signal to compute a digital signature representative of the scan. The digital signature is obtained in the present example by applying the rule: ak(i)>mean maps onto binary ‘1’ and ak(i)<=mean maps onto binary ‘0’. The digitised data set is defined as dk(i) where i runs from 1 to N. The signature of the article may advantageously incorporate further components in addition to the digitised signature of the intensity data just described. These further optional signature components are now described.

Step S6 is an optional step in which a smaller ‘thumbnail’ digital signature is created. In some examples, this can be a realspace thumbnail produced either by averaging together adjacent groups of m readings, or by picking every cth data point, where c is the compression factor of the thumbnail. The latter may be preferable since averaging may disproportionately amplify noise. In other examples, the thumbnail can be based on a Fast Fourier Transform of some or all of the signature data. The same digitisation rule used in Step S5 is then applied to the reduced data set. The thumbnail digitisation is defined as tk(i) where i runs 1 to N/c and c is the compression factor.

Step S7 is an optional step applicable when multiple detector channels exist (i.e. where k>1). The additional component is a cross-correlation component calculated between the intensity data obtained from different ones of the photodetectors. With 2 channels there is one possible cross-correlation coefficient, with 3 channels up to 3, and with 4 channels up to 6 etc. The cross-correlation coefficients can be useful, since it has been found that they are good indicators of material type. For example, for a particular type of document, such as a passport of a given type, or laser printer paper, the cross-correlation coefficients always appear to lie in predictable ranges. A normalised cross-correlation can be calculated between ak(i) and al(i), where k≠l and k,l vary across all of the photodetector channel numbers. The normalised cross-correlation function is defined as:

Another aspect of the cross-correlation function that can be stored for use in later verification is the width of the peak in the cross-correlation function, for example the full width half maximum (FWHM). The use of the cross-correlation coefficients in verification processing is described further below.

Step S8 is another optional step which is to compute a simple intensity average value indicative of the signal intensity distribution. This may be an overall average of each of the mean values for the different detectors or an average for each detector, such as a root mean square (rms) value of ak(i). If the detectors are arranged in pairs either side of normal incidence as in the reader described above, an average for each pair of detectors may be used. The intensity value has been found to be a good crude filter for material type, since it is a simple indication of overall reflectivity and roughness of the sample. For example, one can use as the intensity value the unnormalised rms value after removal of the average value, i.e. the DC background. The rms value provides an indication of the reflectivity of the surface, in that the rms value is related to the surface roughness.

The signature data obtained from scanning an article can be compared against records held in a signature database for verification purposes and/or written to the database to add a new record of the signature to extend the existing database and/or written to the article in encoded form for later verification with or without database access.

A new database record will include the digital signature obtained in Step S5 as well as optionally its smaller thumbnail version obtained in Step S6 for each photodetector channel, the cross-correlation coefficients obtained in Step S7 and the average value(s) obtained in Step S8. Alternatively, the thumbnails may be stored on a separate database of their own optimised for rapid searching, and the rest of the data (including the thumbnails) on a main database.

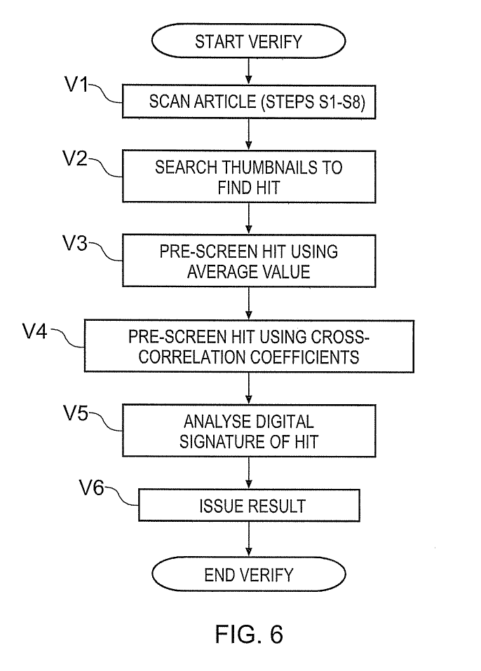

FIG. 6 is a flow diagram showing how a signature of an article obtained from a scan can be verified against a signature database.

In a simple implementation, the database could simply be searched to find a match based on the full set of signature data. However, to speed up the verification process, the process of the present example uses the smaller thumbnails and pre-screening based on the computed average values and cross-correlation coefficients as now described. To provide such a rapid verification process, the verification process is carried out in two main steps, first using the thumbnails derived from the amplitude component of the Fourier transform of the scan data (and optionally also pre-screening based on the computed average values and cross-correlation coefficients) as now described, and second by comparing the scanned and stored full digital signatures with each other.

Verification Step V1 is the first step of the verification process, which is to scan an article according to the process described above, i.e. to perform Scan Steps S1 to S8. This scan obtains a signature for an article which is to be validated against one or more records of existing article signatures Verification Step V2 seeks a candidate match using the thumbnail derived from the Fourier transform amplitude component of the scan signal, which is obtained as explained above with reference to Scan Step S6. Verification Step V2 takes each of the thumbnail entries and evaluates the number of matching bits between it and tk(i+j), where j is a bit offset which is varied to compensate for errors in placement of the scanned area. The value of j is determined and then the thumbnail entry which gives the maximum number of matching bits. This is the ‘hit’ used for further processing. A variation on this would be to include the possibility of passing multiple candidate matches for full testing based on the full digital signature. The thumbnail selection can be based on any suitable criteria, such as passing up to a maximum number of, for example 10, candidate matches, each candidate match being defined as the thumbnails with greater than a certain threshold percentage of matching bits, for example 60%. In the case that there are more than the maximum number of candidate matches, only the best 10 are passed on. If no candidate match is found, the article is rejected (i.e. jump to Verification Step V6 and issue a fail result).

This thumbnail based searching method employed in the present example delivers an overall improved search speed, for the following reasons. As the thumbnail is smaller than the full signature, it takes less time to search using the thumbnail than using the full signature. Where a realspace thumbnail is used, the thumbnail needs to be bit-shifted against the stored thumbnails to determine whether a “hit” has occurred, in the same way that the full signature is bit-shifted against the stored signature to determine a match. The result of the thumbnail search is a shortlist of putative matches, each of which putative matches can then be used to test the full signature against.

Where the thumbnail is based on a Fourier Transform of the signature or part thereof, further advantages may be realised as there is no need to bit-shift the thumbnails during the search. A pseudo-random bit sequence, when Fourier transformed, carries some of the information in the amplitude spectrum and some in the phase spectrum. Any bit shift only affects the phase spectrum, however, and not the amplitude spectrum. Amplitude spectra can therefore be matched without any knowledge of the bit shift. Although some information is lost in discarding the phase spectrum, enough remains in order to obtain a rough match against the database. This allows one or more putative matches to the target to be located in the database. Each of these putative matches can then be compared properly using the conventional real-space method against the new scan as with the realspace thumbnail example.

Verification Step V3 is an optional pre-screening test that is performed before analysing the full digital signature stored for the record against the scanned digital signature. In this pre-screen, the rms values obtained in Scan Step S8 are compared against the corresponding stored values in the database record of the hit. The ‘hit’ is rejected from further processing if the respective average values do not agree within a predefined range. The article is then rejected as non-verified (i.e. jump to Verification Step V6 and issue fail result).

Verification Step V4 is a further optional pre-screening test that is performed before analysing the full digital signature. In this pre-screen, the cross-correlation coefficients obtained in Scan Step S7 are compared against the corresponding stored values in the database record of the hit. The ‘hit’ is rejected from further processing if the respective cross-correlation coefficients do not agree within a predefined range. The article is then rejected as non-verified (i.e. jump to Verification Step V6 and issue fail result).

Another check using the cross-correlation coefficients that could be performed in Verification Step V4 is to check the width of the peak in the cross-correlation function, where the cross-correlation function is evaluated by comparing the value stored from the original scan in Scan Step S7 above and the re-scanned value:

If the width of the re-scanned peak is significantly higher than the width of the original scan, this may be taken as an indicator that the re-scanned article has been tampered with or is otherwise suspicious. For example, this check should beat a fraudster who attempts to fool the system by printing a bar code or other pattern with the same intensity variations that are expected by the photodetectors from the surface being scanned.

Verification Step V5 is the main comparison between the scanned digital signature obtained in Scan Step S5 and the corresponding stored values in the database record of the hit. The full stored digitised signature, dkdb(i) is split into n blocks of q adjacent bits on k detector channels, i.e. there are qk bits per block. In the present example, a typical value for q is 4 and a typical value for k is in the range 1 to 2, making typically 4 to 8 bits per block. The qk bits are then matched against the qk corresponding bits in the stored digital signature dkdb(i+j). If the number of matching bits within the block is greater or equal to some pre-defined threshold zthresh, then the number of matching blocks is incremented. A typical value for zthresh is 7 on a two detector system. For a 1 detector system (k=1), zthresh might typically have a value of 3. This is repeated for all n blocks. This whole process is repeated for different offset values of j, to compensate for errors in placement of the scanned area, until a maximum number of matching blocks is found. Defining M as the maximum number of matching blocks, the probability of an accidental match is calculated by evaluating:

where s is the probability of an accidental match between any two blocks (which in turn depends upon the chosen value of zthreshold ), M is the number of matching blocks and p(M) is the probability of M or more blocks matching accidentally. The value of s is determined by comparing blocks within the database from scans of different objects of similar materials, e.g. a number of scans of paper documents etc. For the example case of q=4, k=2 and z threshold=7, we find a typical value of s is 0.1. If the qk bits were entirely independent, then probability theory would give s=0.01 for z threshold=7. The fact that we find a higher value empirically is because of correlations between the k detector channels (where multiple detectors are used) and also correlations between adjacent bits in the block due to a finite laser spot width. A typical scan of a piece of paper yields around 314 matching blocks out of a total number of 510 blocks, when compared against the data base entry for that piece of paper. Setting M=314, n=510, s=0.1 for the above equation gives a probability of an accidental match of 10-177. As mentioned above, these figures apply to a four detector channel system. The same calculations can be applied to systems with other numbers of detector channels.

Verification Step V6 issues a result of the verification process. The probability result obtained in Verification Step V5 may be used in a pass/fail test in which the benchmark is a pre-defined probability threshold. In this case the probability threshold may be set at a level by the system, or may be a variable parameter set at a level chosen by the user. Alternatively, the probability result may be output to the user as a confidence level, either in raw form as the probability itself, or in a modified form using relative terms (e.g. no match/poor match/good match/excellent match) or other classification. In experiments carried out upon paper, it has generally been found that 75% of bits in agreement represents a good or excellent match, whereas 50% of bits in agreement represents no match.

By way of example, it has been experimentally found that a database comprising 1 million records, with each record containing a 128-bit thumbnail of the Fourier transform amplitude spectrum, can be searched in 1.7 seconds on a standard PC computer of 2004 specification. 10 million entries can be searched in 17 seconds. High-end server computers can be expected to achieve speeds up to 10 times faster than this.

It will be appreciated that many variations are possible. For example, instead of treating the cross-correlation coefficients as a pre-screen component, they could be treated together with the digitised intensity data as part of the main signature. For example the cross-correlation coefficients could be digitised and added to the digitised intensity data. The cross-correlation coefficients could also be digitised on their own and used to generate bit strings or the like which could then be searched in the same way as described above for the thumbnails of the digitised intensity data in order to find the hits.

In one alternative example, step V5 (calculation of the probability of an accidental match) can be performed using a method based on an estimate of the degrees of freedom in the system. For example, if one has a total of 2000 bits of data in which there are 1300 degrees of freedom, then a 75% (1500bits) matching result is the same as 975 (1300×0.75) independent bits matching. The uniqueness is then derived from the number of effective bits as follows:

This equation is identical to the one indicated above, except that here m is the number of matching bits and p(m) is the probability of m or more blocks matching accidentally.

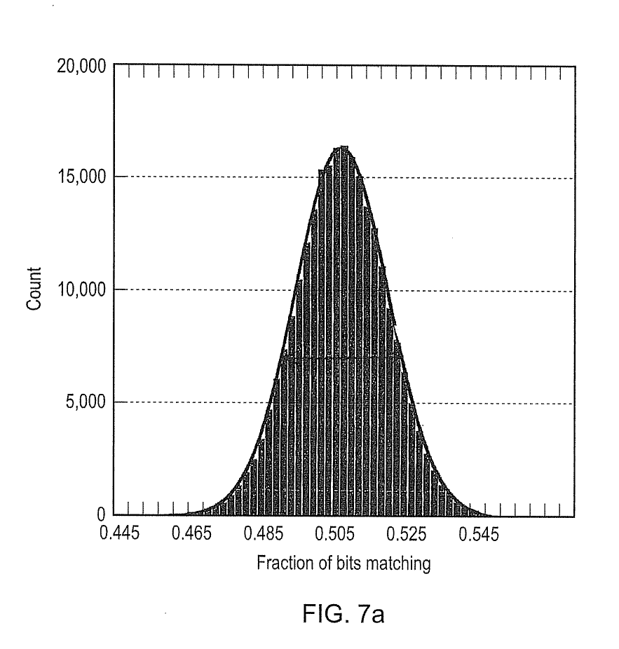

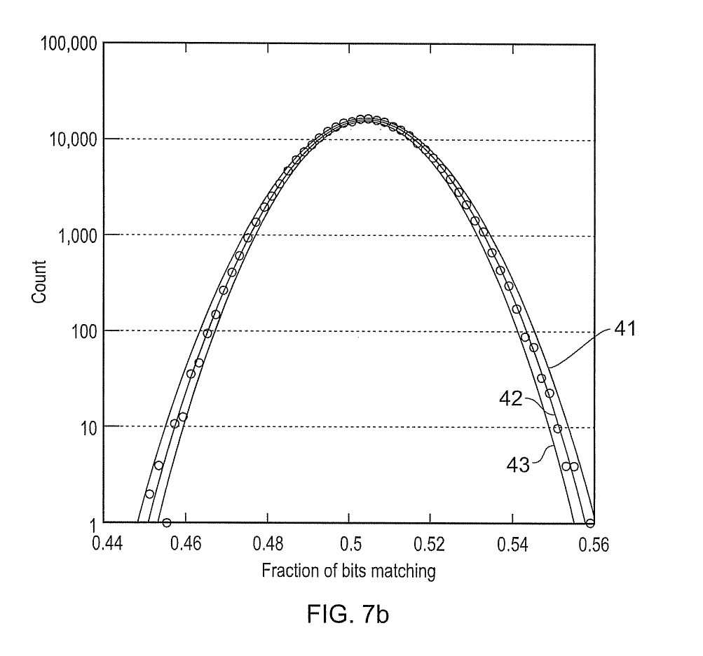

The number of degrees of freedom can be calculated for a given article type as follows. The number of effective bits can be estimated or measured. To measure the effective number of bits, a number of different articles of the given type are scanned and signatures calculated. All of the signatures are then compared to all of the other signatures and a fraction of bits matching result is obtained. An example of a histogram plot of such results is shown in FIG. 7 a. The plot in FIG. 7a is based on 124,500 comparisons between 500 similar items, the signature for each item being based on 2000 data points. The plot represents the results obtained when different items were compared.

From FIG. 7a it can clearly be seen that the results provide a smooth curve centred around a fraction of bits matching result of approximately 0.5. For the data depicted in FIG. 7a, a curve can be fitted to the results, the mean ÿ of which curve is 0.504 and the standard deviation ÿ of which is 0.01218. From the fraction of bits matching plot, the number of degrees of freedom N can be calculated as follows:

In the context of the present example, this gives a number of degrees of freedom N of 1685.

The accuracy of this measure of the degrees of freedom is demonstrated in FIG. 7b. This figure shows three binomial curves plotted onto the experimental of fraction of bits matching. Curve 41 is a binomial curve with a turning point at 0.504 using N=1535, curve 42 is a binomial curve with a turning point at 0.504 using N=1685, and curve 43 is a binomial curve with a turning point at 0.504 using N=1835. It is clear from the plot that the curve 42 fits the experimental data, whereas curves 41 and 43 do not.

For some applications, it may be possible to make an estimate of the number of degrees of freedom rather than use empirical data to determine a value. If one uses a conservative estimate for an item, based on known results for other items made from the same or similar materials, then the system remains robust to false positives whilst maintaining robustness to false negatives.

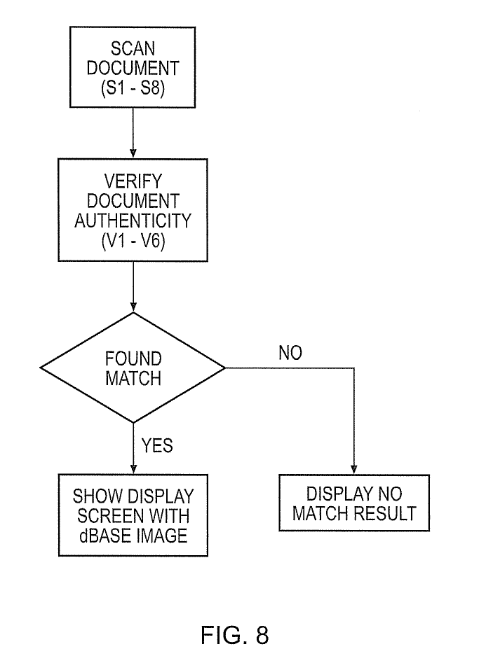

FIG. 8 is a flow diagram showing the overall process of how a document is scanned for verification purposes and the results presented to a user. First the document is scanned according to the scanning steps of FIG. 5. The document authenticity is then verified using the verification steps of FIG. 6. If there is no matching record in the database, a “no match” result can be displayed to a user. If there is a match, this can be displayed to the user using a suitable user interface. The user interface may be a simple yes/no indicator system such as a lamp or LED which turns on/off or from one colour to another for different results. The user interface may also take the form of a point of sale type verification report interface, such as might be used for conventional verification of a credit card. The user interface might be a detailed interface giving various details of the nature of the result, such as the degree of certainty in the result and data describing the original article or that article's owner. Such an interface might be used by a system administrator or implementer to provide feedback on the working of the system. Such an interface might be provided as part of a software package for use on a conventional computer terminal.

It will thus be appreciated that when a database match is found a user can be presented with relevant information in an intuitive and accessible form which can also allow the user to apply his or her own common sense for an additional, informal layer of verification. For example, if the article is a document, any image of the document displayed on the user interface should look like the document presented to the verifying person, and other factors will be of interest such as the confidence level and bibliographic data relating to document origin. The verifying person will be able to apply their experience to make a value judgement as to whether these various pieces of information are self consistent.

On the other hand, the output of a scan verification operation may be fed into some form of automatic control system rather than to a human operator. The automatic control system will then have the output result available for use in operations relating to the article from which the verified (or non-verified) signature was taken.

Thus there have now been described methods for scanning an article to create a signature therefrom and for comparing a resulting scan to an earlier record signature of an article to determine whether the scanned article is the same as the article from which the record signature was taken. These methods can provide a determination of whether the article matches one from which a record scan has already been made to a very high degree of accuracy.

From one point of view, there has thus now been described, in summary, a system in which a digital signature is obtained by digitising a set of data points obtained by scanning a coherent beam over a paper, cardboard or other article, and measuring the scatter. A thumbnail digital signature is also determined, either in realspace by averaging or compressing the data, or by digitising an amplitude spectrum of a Fourier transform of the set of data points. A database of digital signatures and their thumbnails can thus be built up. The authenticity of an article can later be verified by re-scanning the article to determine its digital signature and thumbnail, and then searching the database for a match. Searching is done on the basis of the Fourier transform thumbnail to improve search speed. Speed is improved, since, in a pseudo-random bit sequence, any bit shift only affects the phase spectrum, and not the amplitude spectrum, of a Fourier transform represented in polar co-ordinates. The amplitude spectrum stored in the thumbnail can therefore be matched without any knowledge of the unknown bit shift caused by registry errors between the original scan and the re-scan.

In some examples, the method for extracting a signature from a scanned article can be optimised to provide reliable recognition of an article despite deformations to that article caused by, for example, stretching or shrinkage. Such stretching or shrinkage of an article may be caused by, for example, water damage to a paper or cardboard based article.

Also, an article may appear to a scanner to be stretched or shrunk if the relative speed of the article to the sensors in the scanner is non-linear. This may occur if, for example the article is being moved along a conveyor system, or if the article is being moved through a scanner by a human holding the article. An example of a likely scenario for this to occur is where a human scans, for example, a bank card using a swipe-type scanner.

In some examples, where a scanner is based upon a scan head which moves within the scanner unit relative to an article held stationary against or in the scanner, then linearisation guidance can be provided within the scanner to address any non-linearities in the motion of the scan head. Where the article is moved by a human, these non-linearities can be greatly exaggerated

To address recognition problems which could be caused by these non-linear effects, it is possible to adjust the analysis phase of a scan of an article. Thus a modified validation procedure will now be described with reference to FIG. 44a. The process implemented in this example uses a block-wise analysis of the data to address the non-linearities.

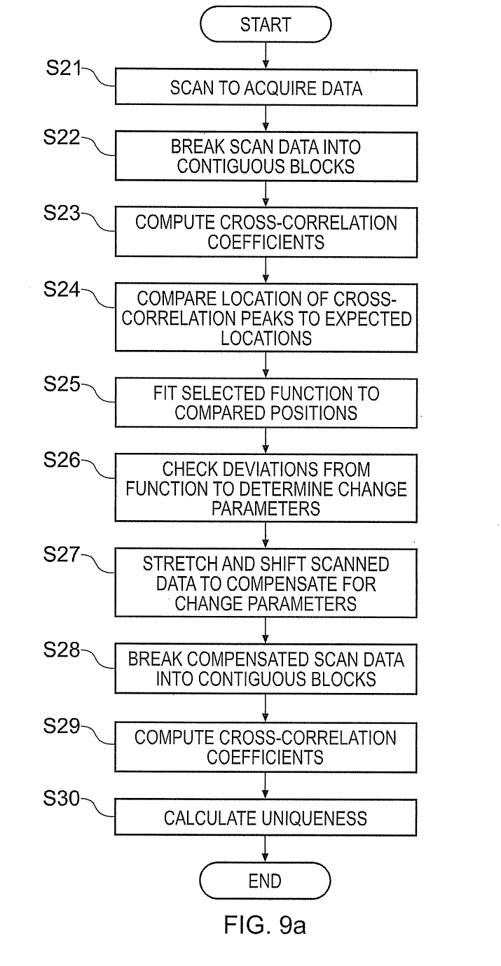

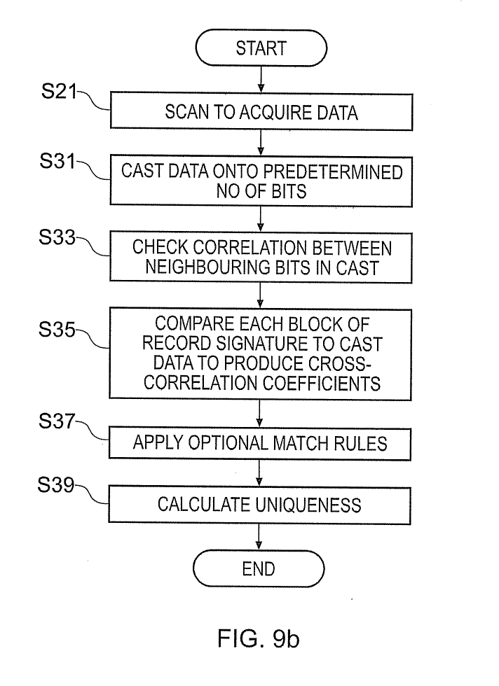

The process carried out in accordance with FIG. 9a can include some or all of the steps of time domain filtering, alternative or additional linearisation, space domain filtering, smoothing and differentiating the data, and digitisation for obtaining the signature and thumbnail described with reference to FIG. 6, but are not shown in FIG. 9a so as not to obscure the content of that figure.

As shown in FIG. 9a, the scanning process for a validation scan using a block-wise analysis starts at step S21 by performing a scan of the article to acquire the date describing the intrinsic properties of the article. This scanned data is then divided into contiguous blocks (which can be performed before or after digitisation and any smoothing/differentiation or the like) at step S22. In one example, a scan area of 1600 mm² (e.g. 40 mm×40 mm) is divided into eight equal length blocks. Each block therefore represents a subsection of the scanned area of the scanned article.

For each of the blocks, a cross-correlation is performed against the equivalent block for each stored signature with which it is intended that article be compared at step S23. This can be performed using a thumbnail approach with one thumbnail for each block. The results of these cross-correlation calculations are then analysed to identify the location of the cross-correlation peak. The location of the cross-correlation peak is then compared at step S24 to the expected location of the peak for the case where a perfectly linear relationship exists between the original and later scans of the article.

As this block-matching technique is a relatively computationally intensive process, in some examples its use may be restricted to use in combination with a thumbnail search such that the block-wise analysis is only applied to a shortlist of potential signature matches identified by the thumbnail search.

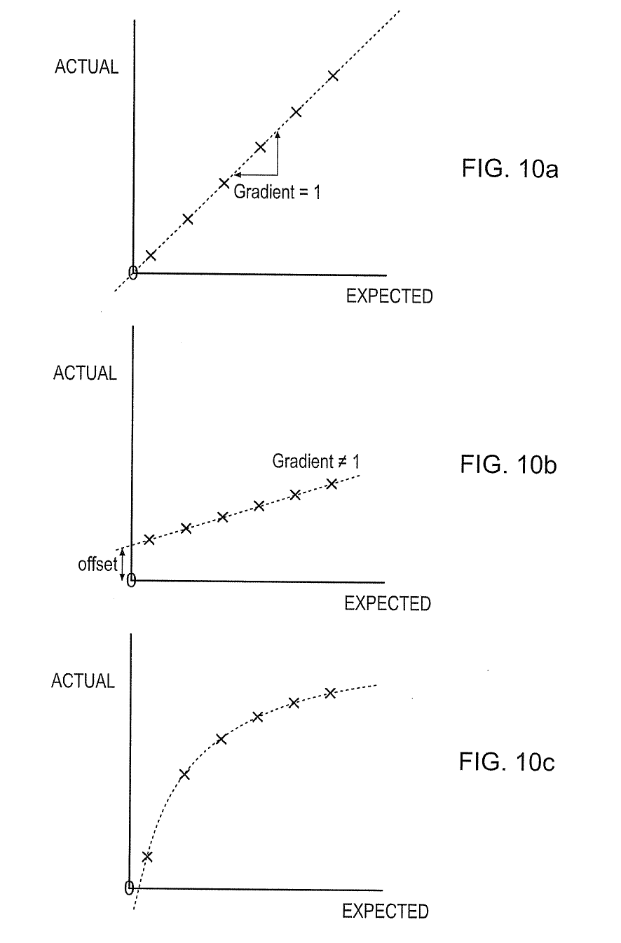

This relationship can be represented graphically as shown in FIGS. 10A, 10B and 10C. In the example of FIG. 10A, the cross-correlation peaks are exactly where expected, such that the motion of the scan head relative to the article has been perfectly linear and the article has not experienced stretch or shrinkage. Thus a plot of actual peak positions against expected peak results in a straight line which passes through the origin and has a gradient of 1.

In the example of FIG. 10B, the cross-correlation peaks are closer together than expected, such that the gradient of a line of best fit is less than 1. Thus the article has shrunk relative to its physical characteristics upon initial scanning. Also, the best fit line does not pass through the origin of the plot. Thus the article is shifted relative to the scan head compared to its position for the record scan.

In the example of FIG. 10C, the cross correlation peaks do not form a straight line. In this example, they approximately fit to a curve representing a y2 function. Thus the movement of the article relative to the scan head has slowed during the scan. Also, as the best fit curve does not cross the origin, it is clear that the article is shifted relative to its position for the record scan.

A variety of functions can be test-fitted to the plot of points of the cross-correlation peaks to find a best-fitting function. Thus curves to account for stretch, shrinkage, misalignment, acceleration, deceleration, and combinations thereof can be used. Examples of suitable functions can include straight line functions, exponential functions, a trigonometric functions, x2 functions and x3 functions.

Once a best-fitting function has been identified at step S25, a set of change parameters can be determined which represent how much each cross-correlation peak is shifted from its expected position at step S26. These compensation parameters can then, at step S27, be applied to the data from the scan taken at step S21 in order substantially to reverse the effects of the shrinkage, stretch, misalignment, acceleration or deceleration on the data from the scan. As will be appreciated, the better the best-fit function obtained at step S25 fits the scan data, the better the compensation effect will be.

The compensated scan data is then broken into contiguous blocks at step S28 as in step S22. The blocks are then individually cross-correlated with the respective blocks of data from the stored signature at step S29 to obtain the cross-correlation coefficients. This time the magnitude of the cross-correlation peaks are analysed to determine the uniqueness factor at step S29. Thus it can be determined whether the scanned article is the same as the article which was scanned when the stored signature was created.

Accordingly, there has now been described an example of a method for compensating for physical deformations in a scanned article, and/or for non-linearities in the motion of the article relative to the scanner. Using this method, a scanned article can be checked against a stored signature for that article obtained from an earlier scan of the article to determine with a high level of certainty whether or not the same article is present at the later scan. Thereby an article constructed from easily distorted material can be reliably recognised. Also, a scanner where the motion of the scanner relative to the article may be non-linear can be used, thereby allowing the use of a low-cost scanner without motion control elements.

An alternative method for performing a block-wise analysis of scan data is presented in FIG. 9b

This method starts at step S21 with performing a scan of the target surface as discussed above with reference to step S21 of FIG. 9a. Once the data has been captured, this scan data is cast onto a predetermined number of bits at step S31. This consists of an effective reduction in the number of bits of scan data to match the cast length. In the present example, the scan data is applied to the cast length by taking evenly spaced bits of the scan data in order to make up the cast data.

Next, step S33, a check is performed to ensure that there is a sufficiently high level of correlation between adjacent bits of the cast data. In practice, it has been found that correlation of around 50% between neighbouring bits is sufficient. If the bits are found not to meet the threshold, then the filter which casts the scan data is adjusted to give a different combination of bits in the cast data.

Once it has been determined that the correlation between neighbouring bits of the cast data is sufficiently high, the cast data is compared to the stored record signature at step S35. This is done by taking each predetermined block of the record signature and comparing it to the cast data. In the present example, the comparison is made between the cast data and an equivalent reduced data set for the record signature. Each block of the record signature is tested against every bit position offset of the cast data, and the position of best match for that block is the bit offset position which returns the highest cross-correlation value.

Once every block of the record signature has been compared to the cast data, a match result (bit match ratio) can be produced for that record signature as the sum of the highest cross-correlation values for each of the blocks. Further candidate record signatures can be compared to the cast data if necessary (depending in some examples upon whether the test is a 1:1 test or a 1 many test).

After the comparison step is completed, optional matching rules can be applied at step S37. These may include forcing the various blocks of the record signature to be in the correct order when producing the bit match ration for a given record signature. For example if the record signature is divided into five blocks (block 1, block 2, block 3, block 4 and block 5), but the best cross-correlation values for the blocks, when tested against the cast data returned a different order of blocks (e.g. block 2, block 3, block 4, block 1, block 5) this result could be rejected and a new total calculated using the best cross-correlation results that keep the blocks in the correct order. This step is optional as, in experimental tests carried out, it has been seen that this type of rule makes little if any difference to the end results. This is believed to be due to the surface identification property operating over the length of the shorter blocks such that, statistically, the possibility of a wrong-order match occurring to create a false positive is extremely low.

Finally, at step S39, using the bit match ratio, the uniqueness can be determined by comparing the whole of the scan data to the whole of the record signature, including shifting the blocks of the record signature against the scan data based on the position of the cross-correlation peaks determined in step S35. This time the magnitude of the cross-correlation peaks are analysed to determine the uniqueness factor at step S39. Thus it can be determined whether the scanned article is the same as the article which was scanned when the stored record signature was created The block size used in this method can be determined in advance to provide for efficient matching and high reliability in the matching. When performing a cross-correlation between a scan data set and a record signature, there is an expectation that a match result will have a bit match ratio of around 0.9. A 1.0 match ratio is not expected due to the biometric-type nature of the property of the surface which is measured by the scan. It is also expected that a non-match will have a bit match ratio of around 0.5. The nature of the blocks as containing fewer bits than the complete signature tends to shift the likely value of the non-match result, leading to an increased chance of finding a false-positive. For example, it has been found by experiment that a block length of 32 bits moves the non-match to approximately 0.75, which is too high and too close to the positive match result at about 0.9 for many applications. Using a block length of 64 bits moves the non-match result down to approximately 0.68, which again may be too high in some applications. Further increasing the block size to 96 bits, shifts the non-match result down to approximately 0.6, which, for most applications, provides more than sufficient separation between the true positive and false positive outcomes. As is clear from the above, increasing the block length increases the separation between non-match and match results as the separation between the match and non-match peaks is a function of the block length. Thus it is clear that the block length can be increased for greater peak separation (and greater discrimination accuracy) at the expense of increased processing complexity caused by the greater number of bits per block. On the other hand, the block length may be made shorter, for lower processing complexity, if less separation between true positive and false positive outcomes is acceptable.

Another characteristic of an article which can be detected using a block-wise analysis of a signature generated based upon an intrinsic property of that article is that of localised damage to the article. For example, such a technique can be used to detect modifications to an article made after an initial record scan.

For example, many documents, such as passports, ID cards and driving licenses, include photographs of the bearer. If an authenticity scan of such an article includes a portion of the photograph, then any alteration made to that photograph will be detected. Taking an arbitrary example of splitting a signature into 10 blocks, three of those blocks may cover a photograph on a document and the other seven cover another part of the document, such as a background material. If the photograph is replaced, then a subsequent rescan of the document can be expected to provide a good match for the seven blocks where no modification has occurred, but the replaced photograph will provide a very poor match. By knowing that those three blocks correspond to the photograph, the fact that all three provide a very poor match can be used to automatically fail the validation of the document, regardless of the average score over the whole signature.

Also, many documents include written indications of one or more persons, for example the name of a person identified by a passport, driving licence or identity card, or the name of a bank account holder. Many documents also include a place where written signature of a bearer or certifier is applied. Using a block-wise analysis of a signature obtained therefrom for validation can detect a modification to alter a name or other important word or number printed or written onto a document. A block which corresponds to the position of an altered printing or writing can be expected to produce a much lower quality match than blocks where no modification has taken place. Thus a modified name or written signature can be detected and the document failed in a validation test even if the overall match of the document is sufficiently high to obtain a pass result.

The area and elements selected for the scan area can depend upon a number of factors, including the element of the document which it is most likely that a fraudster would attempt to alter. For example, for any document including a photograph the most likely alteration target will usually be the photograph as this visually identifies the bearer. Thus a scan area for such a document might beneficially be selected to include a portion of the photograph. Another element which may be subjected to fraudulent modification is the bearer's signature, as it is easy for a person to pretend to have a name other than their own, but harder to copy another person's signature. Therefore for signed documents, particularly those not including a photograph, a scan area may beneficially include a portion of a signature on the document.

In the general case therefore, it can be seen that a test for authenticity of an article can comprise a test for a sufficiently high quality match between a verification signature and a record signature for the whole of the signature, and a sufficiently high match over at least selected blocks of the signatures. Thus regions important to the assessing the authenticity of an article can be selected as being critical to achieving a positive authenticity result.

In some examples, blocks other than those selected as critical blocks may be allowed to present a poor match result. Thus a document may be accepted as authentic despite being torn or otherwise damaged in parts, so long as the critical blocks provide a good match and the signature as a whole provides a good match.

Thus there have now been described a number of examples of a system, method and apparatus for identifying localised damage to an article, and for rejecting an inauthentic an article with localised damage or alteration in predetermined regions thereof Damage or alteration in other regions may be ignored, thereby allowing the document to be recognised as authentic.

In some scanner apparatuses, it is also possible that it may be difficult to determine where a scanned region starts and finishes. Of the examples discussed above, this may be most problematic a processing line type system where the scanner may “see” more than the scan area for the article. One approach to addressing this difficulty would be to define the scan area as starting at the edge of the article. As the data received at the scan head will undergo a clear step change when an article is passed though what was previously free space, the data retrieved at the scan head can be used to determine where the scan starts.

In this example, the scan head is operational prior to the application of the article to the scanner. Thus initially the scan head receives data corresponding to the unoccupied space in front of the scan head. As the article is passed in front of the scan head, the data received by the scan head immediately changes to be data describing the article. Thus the data can be monitored to determine where the article starts and all data prior to that can be discarded. The position and length of the scan area relative to the article leading edge can be determined in a number of ways. The simplest is to make the scan area the entire length of the article, such that the end can be detected by the scan head again picking up data corresponding to free space. Another method is to start and/or stop the recorded data a predetermined number of scan readings from the leading edge. Assuming that the article always moves past the scan head at approximately the same speed, this would result in a consistent scan area. Another alternative is to use actual marks on the article to start and stop the scan region, although this may require more work, in terms of data processing, to determine which captured data corresponds to the scan area and which data can be discarded.

In some examples, a drive motor of the processing line may be fitted with a rotary encoder to provide the speed of the article. This can be used to determine a start and stop position of the scan relative to a detected leading edge of the article. This can also be used to provide speed information for linearization of the data, as discussed above with reference to FIG. 5. The speed can be determined from the encoder periodically, such that the speed is checked once per day, once per hour, once per half hour etc.

In some examples the speed of the processing line can be determined from analysing the data output from the sensors. By knowing in advance the size of the article and by measuring the time which that article takes to pass the scanner, the average speed can be determined. This calculated speed can be used to both locate a scan area relative to the leading edge and to linearise the data, as discussed above with reference to FIG. 5.

Another method for addressing this type of situation is to use a marker or texture feature on the article to indicate the start and/or end of the scan area. This could be identified, for example using the pattern matching technique described above.

Thus there has now been described an number of techniques for scanning an item to gather data based on an intrinsic property of the article, compensating if necessary for damage to the article or non-linearities in the scanning process, and comparing the article to a stored signature based upon a previous scan of an article to determine whether the same article is present for both scans.

Thus an example of a system for obtaining and using a biometric-type signature from an article has been briefly described. For more details of this type of system, the reader is directed to consider the content of the various published patent applications identified above.

As will be appreciated, if a signature is to be used for verification of an article, a record signature for the article is required. A record signature can be encoded onto the article for a self-comparison or stored in a separate database, or both. Where a database is used, it will be appreciated that recording a large number of articles for verification purposes will require a huge database, and the inventors of this application have developed a number of techniques for managing such a database (not described in detail herein).

As an alternative to a large database, the inventors have developed a technique for using a single record signature to identify multiple articles, without a need for a specialist processing of the article after manufacture (or a new manufacture step) and without reducing the security of the resulting system.

The present examples refer to an article made by injection moulding and as such apply principally to plastics articles. However, it is noted that the principles described herein apply also to injection moulded items made from other materials, such as metals (where injection moulding is often called “die-casting”), for example, aluminium or brass.

When an article is made by injection moulding of plastics material, the article is formed by forcing thermoplastics or thermosetting plastics material into a mould. In some cases, multiple moulding processes may be undertaken (so-called “overmoulding”) and in some cases difficult shapes may be formed by using removable “slides” within a mould cavity. A related technique to which the present examples are also applicable is reaction injection moulding, where the setting of the material within the mould is caused by a hardening reaction rather than setting as in conventional injection moulding.

Each mould is used to make multiple items which are intended to be “identical” in manufactured product terms. It will be appreciated that such items may be non-perfectly identical on a number of levels, both macroscopic and microscopic. Typical mould lifetimes may be anywhere from 5000 to 250000 parts.

The surface of an article made by a moulding process is affected by the material of the article, the flow of material into the mould, the arrangement of molecular chains/crystal structure in the setting material, and the internal surface of the mould itself. Thus, while every article created in a given mould has a unique surface pattern as measured by a signature generation process according to FIG. 6 or 9 above, all articles produced in the same mould take on sufficient features form the mould itself to produce common signature elements in all articles made form that mould.

Thus, for each article produced by a given mould, a unique signature is expected when the article is subjected to a signature generation process such as that carried out with reference to FIGS. 6 or 9 above. However, when such signatures for a group of articles all created by the same mould are compared, an underlying mould signature pattern can be identified.

The balance between the relative strengths of the unique surface pattern signature and the mould signature is dependent principally upon the nature of the mould and of the moulded material. Where a mould surface is comparatively rough, the strength of the mould signature is increased and where a mould surface is relatively smooth, the strength of the mould signature is decreased. Also, where the material has a tendency to reform its surface after release from the mould, the strength of the unique surface pattern signature is increased, and vice versa. In practice, it is generally found that the balance between the two signatures is within acceptable bounds for detection of both signatures with sufficient confidence.

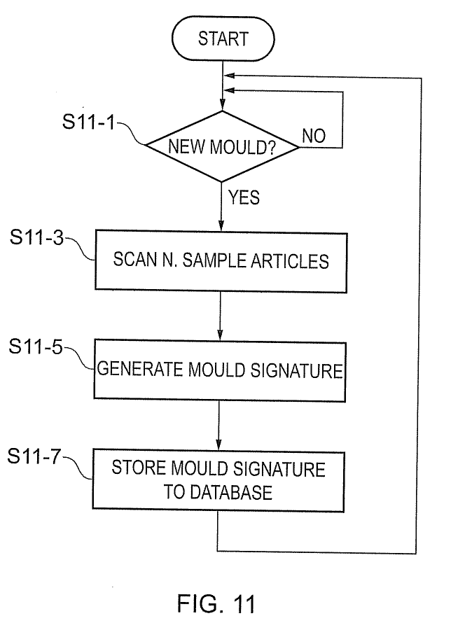

By using this property, articles made by such a manufacture process can be subjected to an authentication/verification process without a need for a large database. FIG. 11 details conceptual process steps for generating a reliable record signature database for a set of articles produced by an injection moulding process.

Starting at step S11-1, check is performed to determine whether a new mould has been installed. If not, the process waits until new mould is installed. If a new mould has been installed, a new database record signature is required for that mould and so processing carries on at step S11-3. At step S11-3 a number of sample articles from the mould are scanned and signatures produced therefrom. The number of articles used for this process can be varied depending upon the expected strength of the mould signature and the moulded material. In many cases, a sample group of around 100 articles is more than sufficient to make an accurate determination of the mould signature.

Next, at step S11-5, the obtained signatures from the sample articles are processed to determine a generate a “class signature” for the particular mould. This signature may also be termed a “mould signature”.

Finally, at step S11-7, the mould signature is stored into a record signature database. Following this, the process returns to waiting for a next mould change.

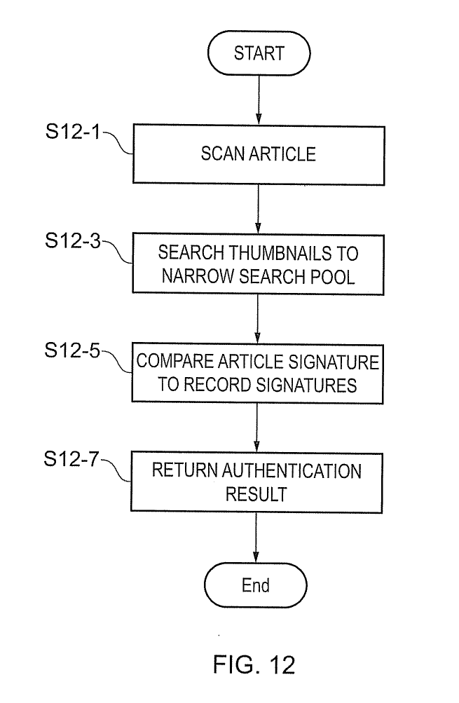

Having populated a record signature database in this way, any authentication checks of an article manufactured by this moulding process can be carried out as follows. With reference to FIG. 12, at step S12-1, the article is scanned to create a signature. Next, at optional Step S12-3, a thumbnail search through the record database is performed to narrow the search pool for which a full comparison is to be performed. Then, at step S12-5, the signature for the article is compared to the either all record signatures in the database or if optional step S12-3 is performed to the record signatures identified thereby. This comparison is typically a cross-correlation as described above with reference to FIGS. 1 to 10. Each record signature against which the article signature is compared, in both steps S12-3 and S12-5 can be a record signature for a mould rather than for an individual article. In some examples, the record database may include a mixture of individual article record signatures and mould signatures.

Using the comparison result, the article can be verified as authentic if a match was found, or rejected as unauthentic if no match was found (S12-7).

Thus there has now been described a system for using a class signature for a given article forming apparatus to verify the authenticity of a number of articles all produced using that forming apparatus. Thereby, a database size of record signatures can be reduced without compromising verification accuracy or reliability.

Such an arrangement can be very beneficial in a number of fields of application. For example, in cases where an article needs to be verified as authentic in order to detect counterfeit goods, the checking database can be reduced in size to speed authentication checks. In some cases, the database may even be small enough to be viably carried within a handheld checking apparatus to avoid a need for a connection to a remote database for authenticity verification.

Also, such a system can be very useful in quality control systems. Taking the example of a product retuned by a consumer as faulty, any defect in that product arising from the injection moulding manufacture process can be traced to an individual mould easily by a single database check. This enables easy identification of any further products which may suffer from a like defect, thus allowing any recall or replacement program to be specifically targeted to the output from a particular mould, avoiding the need for large numbers of non-faulty products to be recalled, repaired or replaced.

As has been mentioned above, the signature derived from each article can be expected to include article specific signature elements as well as the mould-derived signature elements. For some purposes, it may be appropriate to store in a record database both a mould signature and in individual article signature. In fact, separate mould-based and article based record databases could be maintained. Using such a system, the mould-based record signature database could be used for all authentication purposes relating to the class of articles, such as quality control of articles in a manufacturing context and authentication of a spare part as genuine. The article based record signature database could be used for purposes where a specific article needs to be identified, such as where the article represents or provides some form of entitlement for the owner/bearer.

Although the invention has been described with reference to the above specific examples, it will be appreciated by those skilled in the art that the invention can be embodied in many other forms.

1. A method of authenticating an article comprising:
generating a signature from an article using a method of directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points;
comparing the signature for the article to a stored signature for a mould used to produce articles; and
determining an authentication result based upon a comparison result between the article signature and stored mould signature.

2. The method of claim 1, wherein the mould is an injection moulding mould.

3. The method of claim 1, wherein the stored signature for the mould is generated from a sample of fewer than all articles produced from the mould.

4. The method of claim 1, wherein the stored signature for the mould is generated from a signature from an article produced from the mould using a method of directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points.

5. The method of claim 1, wherein the signature for the article includes signature elements relating uniquely to the article in addition to elements relating to the mould.

6. The method of claim 1, wherein the article is made from thermosetting plastics material or thermoplastics material.

7. A system for authenticating an article comprising:
a signature generator that directs coherent radiation sequentially onto each of plurality of regions of a surface of the article; collects a set comprising groups of data points from signals obtained when the coherent radiation scatters from the different regions of the article, wherein different ones of the groups of data points relate to scatter from the respective different regions of the article; and determines a signature of the article from the set of data points;
a comparator that compares the signature for the article to a stored signature for a mould used to produce articles; and
a determiner that determines an authentication result based upon a comparison result between the article signature and stored mould signature.

8. The system of claim 7, wherein the mould is an injection moulding mould.

9. The system of claim 7, wherein the stored signature for the mould is generated from a sample of fewer than all articles produced from the mould.

10. The system of claim 7, wherein the stored signature for the mould is generated from a signature from an article produced from the mould using a method of directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points.

11. The system of claim 7, wherein the signature for the article includes signature elements relating uniquely to the article in addition to elements relating to the mould.

12. The system of claim 7, wherein the article is made from thermosetting plastics material or thermoplastics material.

13. A method for authenticating an article comprising:
a step for generating a signature from an article using a method of directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points;
a step for comparing the signature for the article to a stored signature for a mould used to produce articles; and
a step for determining an authentication result based upon a comparison result between the article signature and stored mould signature.

14. A method of generating a collective signature for articles produced in a mould, the method comprising:
for each of a plurality of articles produced from the mould, generating a signature from the article using a method of directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points;
comparing the signatures produced from the plurality of articles to determine a set of common signature elements;
creating a collective signature from the set of common elements.
